(19) United States
(12) Patent Application Publication
(10) Pub. No.: US 2011/0241955 A1
(43) Pub. Date: Oct. 6, 2011

(54) ANTENNA AND MANUFACTURING METHOD THEREFOR

(75) Inventors: Osamu Amano, Tokyo (JP); Shuichi Koreeda, Tokyo (JP); Yukio Kamata, Kanagawa (JP); Makoto Ando, Tokyo (JP)

(73) Assignees: NEC TOSHIBA SPACE SYSTEMS, LTD., Tokyo (JP); JAPAN AEROSPACE EXPLORATION AGENCY, Tokyo (JP)

(21) Appl. No.: 13/139,469

(22) PCT Filed: Dec. 10, 2009
(86) PCT No.: PCT/JP2009/071010

§ 371 Date: Jun. 13, 2011

(30) Foreign Application Priority Data
Dec. 16, 2008 (JP) 2008-319714

(51) Int. Cl. H01Q 13/10; H01P 11/00; H01Q 1/50

(52) U.S. Cl. 343/767; 29/600; 343/906

(57) ABSTRACT

Provided is an antenna capable of establishing electrical conductivity between a flange-like short-circuit section of a power supply section and a thin metal plate even in a harsh temperature environment in a space environment. Under a state in which an apical portion of a power supply section is inserted from an outer side of a face plate into a hole for the power supply section of a thin metal plate, a dielectric plate, and a metal plate, a plurality of screws are inserted from the outer side of a flange-like short-circuit section through a plurality of insertion holes of the flange-like short-circuit section, the thin metal plate, and the dielectric plate, and the plurality of screws are threadingly inserted into a plurality of tapped holes of the metal plate so that electrical conductivity between the flange-like short-circuit section and the thin metal plate is established through direct contact.

### TECHNICAL FIELD

This invention relates to an antenna, and more particularly, to an antenna to be mounted on a satellite. This invention also relates to a manufacturing method for the antenna.

### BACKGROUND ART

In general, this type of antenna is structured so that two flat metal plates are used and supported in parallel to each other by a metal ring provided on the respective outer peripheral portions. In a case where the antenna is so designed to withstand a mechanical environment at a time of launching a satellite provided with the antenna mounted thereon, if the antenna has a diameter of about 1 m, even a metal material is required to have a thickness of about 2 to 3 mm, and hence the mass of the antenna becomes larger. Such antenna is not suited to use as an antenna to be mounted on the satellite, which has a severe restriction on the mass thereof.

Japanese Unexamined Patent Application Publication (JP-A) No. 2001-345634 (Patent Document 1) discloses, in paragraph [0015], that the copper foil is attached to the flat dielectric plate and the coaxial connector is fixed to the flat dielectric plate by soldering or the like.

Japanese Unexamined Patent Application Publication (JP-A) No. Hei 8-236220 (Patent Document 2) discloses, in paragraph [0003] and FIG. 3, the fixing structure in which the fixing screws are inserted through the through-holes of the coaxial connector with flange and the through-holes of the thin plate, and threadingly engaged with the tapped holes of the support so that the coaxial connector with flange and the thin plate are sandwiched between the fixing screws and the support.

### DISCLOSURE OF THE INVENTION

### Problem to be Solved by the Invention

As a related art, in a case where the antenna main body is formed by using a dielectric honeycomb for reducing its weight and by attaching the copper foil (thin metal plate) to the outermost layer thereof, it is impossible to couple a power supply section (for example, coaxial connector) including an apical portion and a flange-like short-circuit section to the antenna main body with screws or the like. Even if soldering or the like is performed to provide electrical connection between the flange-like short-circuit section of the power supply section and the copper foil, the following drawback resides in this method. That is, in a case where the antenna is repeatedly exposed to a harsh temperature environment of plus and minus one hundred and several tens of degrees Celsius in the space environment, a crack may occur in the solders and the like because of, for example, a difference in coefficient of linear expansion of the metal material, which leads to failure in electrical conductivity.

### Means to Solve the Problem

It is an exemplary object of this invention to provide an antenna and a manufacturing method therefor, which are capable of establishing electrical conductivity between a flange-like short-circuit section of a power supply section and a thin metal plate (for example, copper foil) even in a harsh temperature environment in a space environment.

According to a first aspect of this invention,

provided is an antenna, including:

a first face plate;

a second face plate parallel to the first face plate; and

a power supply section including:
an apical portion; and
a flange-like short-circuit section,

in which the first face plate includes:
a first thin metal plate on an outer side; and
a first dielectric plate on an inner side,

in which the second face plate includes:
a second thin metal plate on the outer side; and
a second dielectric plate on the inner side,

in which the antenna further includes a fastening plate on the inner side of the second dielectric plate,

in which the second thin metal plate, the second dielectric plate, and the fastening plate each include, at a center portion thereof, a hole for the power supply section allowing insertion of the apical portion and forbidding insertion of the flange-like short-circuit section,

in which the flange-like short-circuit section, the second thin metal plate, and the second dielectric plate each include a plurality of insertion holes, through which a plurality of screws are inserted,

in which the fastening plate includes a plurality of tapped holes, into which the plurality of screws are threadingly inserted, and

in which, under a state in which the apical portion is inserted from the outer side of the second face plate into the hole for the power supply section of the second thin metal plate, the second dielectric plate, and the fastening plate, the plurality of screws are inserted from the outer side of the flange-like short-circuit section through the plurality of insertion holes of the flange-like short-circuit section, the second thin metal plate, and the second dielectric plate, and the plurality of screws are threadingly inserted into the plurality of tapped holes of the fastening plate so that electrical conductivity between the flange-like short-circuit section and the second thin metal plate is established through direct contact.

According to a second aspect of this invention,

provided is a manufacturing method for an antenna,

the antenna including:

a first face plate;

a second face plate parallel to the first face plate; and

a power supply section including:
an apical portion; and
a flange-like short-circuit section,

the manufacturing method including, when fixing the power supply section to the second face plate:

preparing, as the second face plate, a face plate including a thin metal plate on an outer side and a dielectric plate on an inner side;

further preparing a fastening plate on the inner side of the dielectric plate,
the thin metal plate, the dielectric plate, and the fastening plate each including, at a center portion thereof, a hole for the power supply section allowing insertion of the apical portion and forbidding insertion of the flange-like short-circuit section,
the flange-like short-circuit section, the thin metal plate, and the dielectric plate each including a plurality of insertion holes, through which a plurality of screws are inserted,
the fastening plate including a plurality of tapped holes, into which the plurality of screws are threadingly inserted; and

under a state in which the apical portion is inserted from the outer side of the second face plate into the hole for the power supply section of the thin metal plate, the dielectric plate, and the fastening plate, inserting the plurality of screws from the outer side of the flange-like short-circuit section through the plurality of insertion holes of the flange-like short-circuit section, the thin metal plate, and the dielectric plate, and threadingly inserting the plurality of screws into the plurality of tapped holes of the fastening plate so that electrical conductivity between the flange-like short-circuit section and the thin metal plate is established through direct contact.

### Effect of the Invention

According to this invention, it is possible to obtain the antenna and the manufacturing method therefor, which are capable of establishing the electrical conductivity between the flange-like short-circuit section of the power supply section and the thin metal plate (for example, copper foil) even in the harsh temperature environment in the space environment.

As described above, Japanese Unexamined Patent Application Publication (JP-A) No. 2001-345634 (Patent Document 1) cited above discloses that the copper foil is attached to the flat dielectric plate and the coaxial connector is fixed to the flat dielectric plate by soldering or the like. However, Japanese Unexamined Patent Application Publication (JP-A) No. 2001-345634 (Patent Document 1) cited above does not disclose such a constituent feature of the invention of this application that “electrical conductivity between the flange-like short-circuit section and the thin metal plate is established through direct contact”. Further, Japanese Unexamined Patent Application Publication (JP-A) No. 2001-345634 (Patent Document 1) cited above does not disclose the “first face plate” corresponding to the constituent feature of the invention of this application, and does not disclose the “antenna including the first face plate and the second face plate parallel to the first face plate”.

Similarly, Japanese Unexamined Patent Application Publication (JP-A) No. Hei 8-236220 (Patent Document 2) cited above does not disclose such a constituent feature of the invention of this application that “electrical conductivity between the flange-like short-circuit section and the thin metal plate is established”. Further, Japanese Unexamined Patent Application Publication (JP-A) No. Hei 8-236220 (Patent Document 2) cited above does not disclose the “first face plate” corresponding to the constituent feature of the invention of this application, and does not disclose the “antenna including the first face plate and the second face plate parallel to the first face plate”.

### BRIEF DESCRIPTION OF THE DRAWINGS

FIG. 1 is a sectional view of an antenna according to a first exemplary embodiment of this invention.

FIG. 2 is an explanatory view illustrating a manufacturing method for the antenna of FIG. 1.

FIG. 3 is an explanatory view illustrating the manufacturing method for the antenna of FIG. 1.

FIG. 4 is an explanatory view illustrating the manufacturing method for the antenna of

FIG. 5 is an explanatory view illustrating the manufacturing method for the antenna of

### MODE FOR EMBODYING THE INVENTION

Now, referring to the drawings, description is given of an exemplary embodiment of this invention.

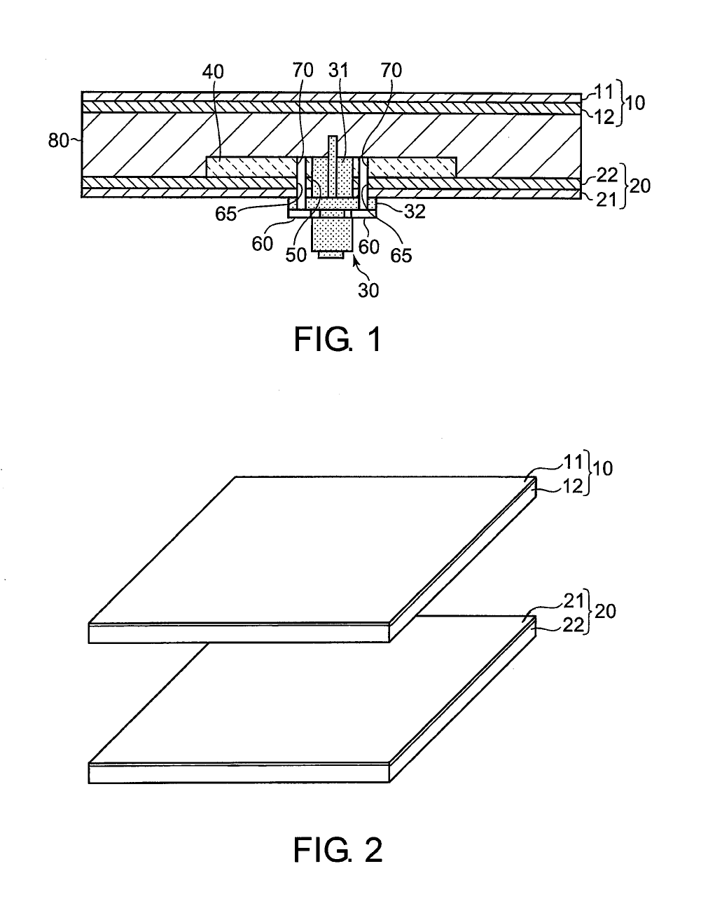

Referring to FIG. 1, an antenna according to a first exemplary embodiment of this invention includes a first face plate 10, a second face plate 20 parallel to the first face plate 10, and a power supply section 30. The power supply section 30 is, for example, a coaxial connector, and includes an apical portion 31 and a flange-like short-circuit section 32. A center conductor protrudes from the apical portion 31.

The first face plate 10 includes a first thin metal plate 11 on an outer side and a first dielectric plate 12 on an inner side, while the second face plate 20 includes a second thin metal plate 21 on the outer side and a second dielectric plate 22 on the inner side. The first thin metal plate 11 and the second thin metal plate 21 are each made of copper foil. The first dielectric plate 12 and the second dielectric plate 22 are each, for example, a composite dielectric plate.

The antenna of the exemplary embodiment further includes a metal plate 40 serving as a fastening plate on an inner side of the second dielectric plate 22. The metal plate 40 of the figure is a ring-like metal plate (ring-like fastening plate).

The second thin metal plate 21, the second dielectric plate 22, and the metal plate 40 each have, at a center portion thereof, a hole 50 for power supply section with a size allowing insertion of the apical portion 31 of the power supply section 30 and forbidding insertion of the flange-like short-circuit section 32 of the power supply section 30.

The flange-like short-circuit section 32, the second thin metal plate (copper foil) 21, and the second dielectric plate 22 each have a plurality of insertion holes 65, through which a plurality of screws 60 are inserted.

The metal plate (ring-like metal plate) 40 has a plurality of tapped holes 70, into which the plurality of screws 60 are threadingly inserted.

Under a state in which the apical portion 31 of the power supply section 30 is inserted from the outer side of the second face plate 20 into the hole 50 for power supply section of the second thin metal plate (copper foil) 21, the second dielectric plate 22, and the metal plate (ring-like metal plate) 40, the plurality of screws 60 are inserted from the outer side of the flange-like short-circuit section 32 of the power supply section 30 through the plurality of insertion holes 65 of the flange-like short-circuit section 32, the second thin metal plate (copper foil) 21, and the second dielectric plate 22. Then, the plurality of screws 60 are threadingly inserted into the plurality of tapped holes 70 of the metal plate 40. Accordingly, the power supply section 30 is fixed to the second face plate 20, and electrical conductivity between the flange-like short-circuit section 32 of the power supply section 30 and the second thin metal plate (copper foil) 21 is established through direct contact without soldering.

There is provided a dielectric honeycomb 80 between the first dielectric plate 12 and the metal plate (ring-like metal plate) 40, and between the flange-like short-circuit section 12 and the second dielectric plate 22.

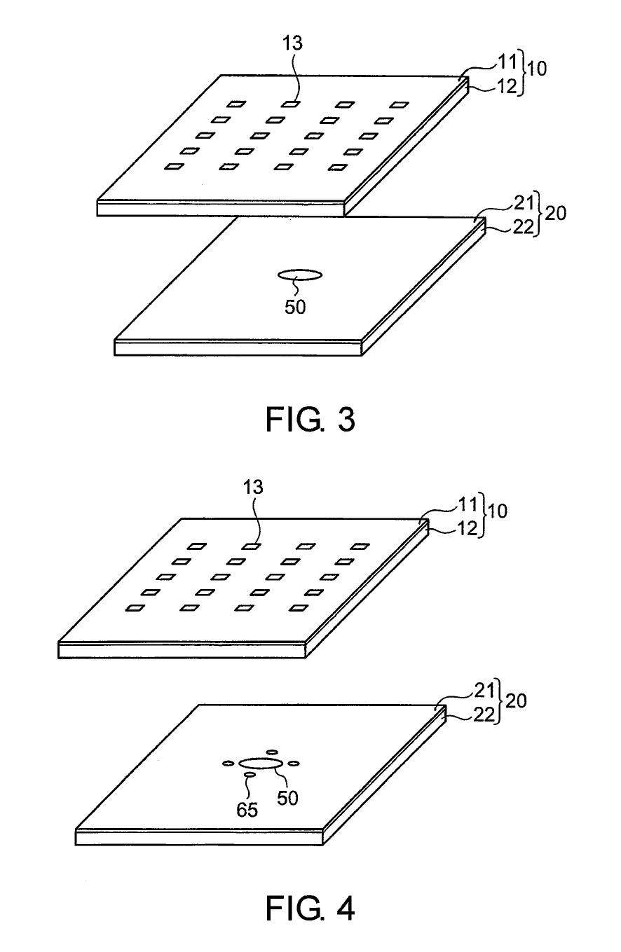

The first face plate 10 has slots 13 (FIG. 3).

The antenna of the exemplary embodiment is an antenna to be mounted on a satellite, and is a radial line slot array antenna with honeycomb structure.

As described above, the lightweight composite dielectric plate 22 with the copper foil 21 is used for the antenna of the exemplary embodiment to obtain a high strength. Further, the ring-like metal plate 40 for fastening the power supply section 30 is provided on the inner side of the lightweight composite dielectric plate 22 with the copper foil 21. The copper foil 21 has a thickness of a skin depth or more, which is necessary to perform radio frequency (RF) transmission. Because the ring-like metal plate 40 is provided on the inner side of the composite dielectric plate 22, the electrical conductivity of the flange-like short-circuit section 32 of the power supply section 30 with respect to the metal foil plate 21 can be established stably by using the screws 60 or the like. The electrical conductivity of the flange-like short-circuit section 32 of the power supply section 30 with respect to the metal foil plate 21 can be established without soldering.

The above-mentioned antenna is manufactured as follows.

As illustrated in FIG. 2, the first face plate 10 including the first thin metal plate (copper foil) 11 on the outer side and the first dielectric plate 12 on the inner side, and the second face plate 20 including the thin metal plate (copper foil) 21 on the outer side and the dielectric plate 22 on the inner side (the second face plate 20 of the figure is reversed when used) are prepared. At this time, the thin metal plate (copper foil) 11 and the first dielectric plate 12 are integrally formed to obtain the first face plate 10, and the thin metal plate (copper foil) 21 and the dielectric plate 22 are integrally formed to obtain the second face plate 20.

Subsequently, referring to FIG. 1, the metal plate (ring-like metal plate) 40, which is to serve as the fastening plate (ring-like fastening plate) on the inner side of the dielectric plate 22, is prepared. The metal plate (ring-like metal plate) 40 has, at the center portion thereof, the hole 50 for power supply section allowing insertion of the apical portion 31 of the power supply section 30 and forbidding insertion of the flange-like short-circuit section 32 of the power supply section 30. Further, the metal plate (ring-like metal plate) 40 has the plurality of tapped holes 70, into which the plurality of screws 60 are threadingly inserted.

Subsequently, as illustrated in FIG. 3, the first face plate 10 is subjected to slot etching to form the slots 13, and the second face plate 20 is subjected to etching for power supply section to form the hole 50 for power supply section. Accordingly, the thin metal plate (copper foil) 21 and the dielectric plate 22 each have, at the center portion thereof, the hole 50 for power supply section allowing insertion of the apical portion 31 of the power supply section 30 and forbidding insertion of the flange-like short-circuit section 32 of the power supply section 30.

Subsequently, as illustrated in FIG. 4, the plurality of insertion holes 65 are formed in the second face plate 20 at positions corresponding to the tapped holes 70 of the metal plate (ring-like metal plate) 40 (FIG. 1) for fastening the power supply section 30. Accordingly, the thin metal plate (copper foil) 21 and the dielectric plate 22 each have the plurality of insertion holes 65, through which the plurality of screws 60 are inserted.

Subsequently, referring to FIG. 1, the plurality of insertion holes 65, through which the plurality of screws 60 are inserted, are formed also in the flange-like short-circuit section 32 of the power supply section 30.

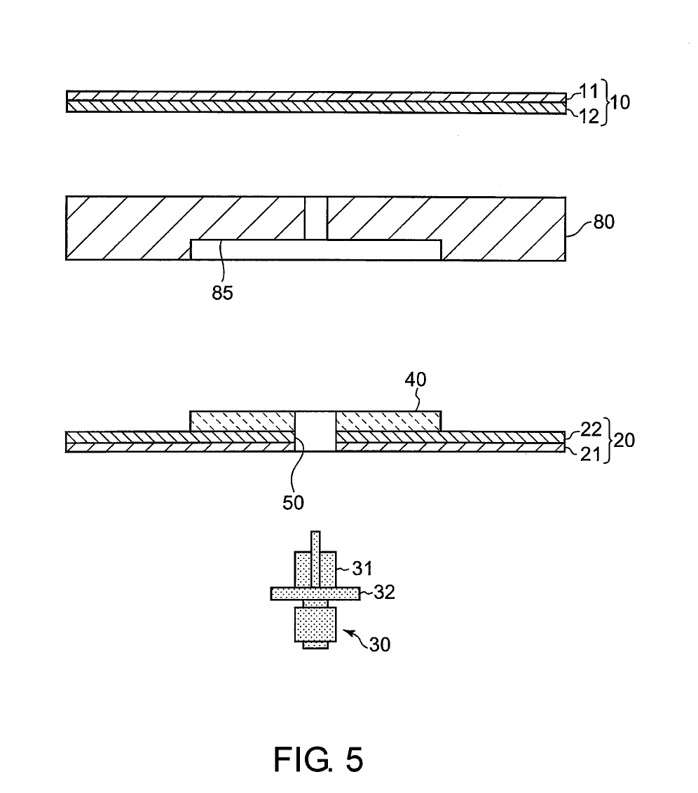

Subsequently, as illustrated in FIG. 5, the metal plate (ring-like metal plate) 40 is bonded to the inner side of the dielectric plate 22 of the second face plate 20, and a fitted portion 85 of the dielectric honeycomb 80, into which the metal plate (ring-like metal plate) 40 is fitted, is cut out in advance. Note that, illustration of the insertion holes 65 and the tapped holes 70 is omitted in FIG. 5.

Finally, adhesive films (not shown) are sandwiched between the first face plate 10 and the dielectric honeycomb 80, and between the second face plate 20 and the dielectric honeycomb 80, respectively, and after heat and pressure forming, the tapped holes 70 of the metal plate (ring-like metal plate) 40 and the insertion holes 65 of the second face plate 20 are used to integrate the power supply section 30. In this manner, the antenna of FIG. 1 is completed.

In other words, referring to FIGS. 5 and 1, under the state in which the apical portion 31 of the power supply section 30 is inserted from the outer side of the second face plate 20 into the hole 50 for power supply section of the thin metal plate (copper foil) 21, the dielectric plate 22, and the metal plate (ring-like metal plate) 40, the plurality of screws 60 are inserted from the outer side of the flange-like short-circuit section 32 of the power supply section 30 through the plurality of insertion holes 65 of the flange-like short-circuit section 32, the thin metal plate (copper foil) 21, and the dielectric plate 22. Then, the plurality of screws 60 are threadingly inserted into the plurality of tapped holes 70 of the metal plate 40. Accordingly, the electrical conductivity between the flange-like short-circuit section 32 and the thin metal plate (copper foil) 21 is established through direct contact.

By using the thin metal plates (copper foil), the first face plate 10 and the second face plate 20 which are parallel to each other may be thin, which contributes to reduction in mass. In addition, by fastening the power supply section 30 directly to the second face plate 20 with the screws, electrical connection between the flange-like short-circuit section 32 of the power supply section 30 and the thin metal plate (copper foil) 21 of the second face plate 20 can be established. Thus, there can be obtained structure which has no excessive thermal stress applied to a test sample at the time of manufacturing and has high resistance to the heat cycle.

Aspects of the exemplary embodiment of this invention are described below.

(1) An antenna includes:

a first face plate;

a second face plate parallel to the first face plate; and

a power supply section including:
an apical portion; and
a flange-like short-circuit section,

in which the first face plate includes:
a first thin metal plate on an outer side; and
a first dielectric plate on an inner side,

in which the second face plate includes:
a second thin metal plate on the outer side; and
a second dielectric plate on the inner side,

in which the antenna further includes a fastening plate on the inner side of the second dielectric plate,

in which the second thin metal plate, the second dielectric plate, and the fastening plate each include, at a center portion thereof, a hole for the power supply section allowing insertion of the apical portion and forbidding insertion of the flange-like short-circuit section,

in which the flange-like short-circuit section, the second thin metal plate, and the second dielectric plate each include a plurality of insertion holes, through which a plurality of screws are inserted,

in which the fastening plate includes a plurality of tapped holes, into which the plurality of screws are threadingly inserted, and

in which, under a state in which the apical portion is inserted from the outer side of the second face plate into the hole for the power supply section of the second thin metal plate, the second dielectric plate, and the fastening plate, the plurality of screws are inserted from the outer side of the flange-like short-circuit section through the plurality of insertion holes of the flange-like short-circuit section, the second thin metal plate, and the second dielectric plate, and the plurality of screws are threadingly inserted into the plurality of tapped holes of the fastening plate so that electrical conductivity between the flange-like short-circuit section and the second thin metal plate is established through direct contact.

(2) In the antenna described in the above item (1), under the state in which the apical portion is inserted from the outer side of the second face plate into the hole for the power supply section of the second thin metal plate, the second dielectric plate, and the fastening plate, the plurality of screws are inserted from the outer side of the flange-like short-circuit section through the plurality of insertion holes of the flange-like short-circuit section, the second thin metal plate, and the second dielectric plate, and the plurality of screws are threadingly inserted into the plurality of tapped holes of the fastening plate so that the electrical conductivity between the flange-like short-circuit section and the second thin metal plate is established through the direct contact without soldering.

(3) In the antenna described in the above item (1), under the state in which the apical portion is inserted from the outer side of the second face plate into the hole for the power supply section of the second thin metal plate, the second dielectric plate, and the fastening plate, the plurality of screws are inserted from the outer side of the flange-like short-circuit section through the plurality of insertion holes of the flange-like short-circuit section, the second thin metal plate, and the second dielectric plate, and the plurality of screws are threadingly inserted into the plurality of tapped holes of the fastening plate so that the power supply section is fixed to the second face plate, and the electrical conductivity between the flange-like short-circuit section and the second thin metal plate is established through the direct contact without soldering.

(4) In the antenna described in any one of the above items (1) to (3), the fastening plate includes a ring-like fastening plate having the hole for the power supply section formed at the center portion thereof.

(5) In the antenna described in the above item (4), the antenna further includes a dielectric honeycomb between the first dielectric plate and the ring-like fastening plate, and between the first dielectric plate and the second dielectric plate.

(6) In the antenna described in any one of the above items (1) to (5), the first thin metal plate and the second thin metal plate are each made of copper foil.

(7) In the antenna described in any one of the above items (1) to (6), the first face plate includes a slot.

(8) In the antenna described in any one of the above items (1) to (7), in which the antenna includes an antenna to be mounted on a satellite.

(9) Provided is a manufacturing method for an antenna,

the antenna including:

a first face plate;

a second face plate parallel to the first face plate; and

a power supply section including:
an apical portion; and
a flange-like short-circuit section,

the manufacturing method including, when fixing the power supply section to the second face plate:

preparing, as the second face plate, a face plate including a thin metal plate on an outer side and a dielectric plate on an inner side;

further preparing a fastening plate on the inner side of the dielectric plate,
the thin metal plate, the dielectric plate, and the fastening plate each including, at a center portion thereof, a hole for the power supply section allowing insertion of the apical portion and forbidding insertion of the flange-like short-circuit section,
the flange-like short-circuit section, the thin metal plate, and the dielectric plate each including a plurality of insertion holes, through which a plurality of screws are inserted,
the fastening plate including a plurality of tapped holes, into which the plurality of screws are threadingly inserted; and

under a state in which the apical portion is inserted from the outer side of the second face plate into the hole for the power supply section of the thin metal plate, the dielectric plate, and the fastening plate, inserting the plurality of screws from the outer side of the flange-like short-circuit section through the plurality of insertion holes of the flange-like short-circuit section, the thin metal plate, and the dielectric plate, and threadingly inserting the plurality of screws into the plurality of tapped holes of the fastening plate so that electrical conductivity between the flange-like short-circuit section and the thin metal plate is established through direct contact.

(10) In the manufacturing method for an antenna described in the above item (9), under the state in which the apical portion is inserted from the outer side of the second face plate into the hole for the power supply section of the thin metal plate, the dielectric plate, and the fastening plate, the plurality of screws are inserted from the outer side of the flange-like short-circuit section through the plurality of insertion holes of the flange-like short-circuit section, the thin metal plate, and the dielectric plate, and the plurality of screws are threadingly inserted into the plurality of tapped holes of the fastening plate so that the electrical conductivity between the flange-like short-circuit section and the thin metal plate is established through the direct contact without soldering.

(11) In the manufacturing method for an antenna described in the above item (9) or (10), the fastening plate includes a ring-like fastening plate having the hole for the power supply section formed at the center portion thereof.

(12) In the manufacturing method for an antenna described in any one of the above items (9) to (11), the thin metal plate is made of copper foil.

(13) In the manufacturing method for an antenna described in any one of the above items (9) to (12), in which the antenna includes an antenna to be mounted on a satellite.

While the invention has been particularly shown and described with reference to the exemplary embodiment thereof, the invention is not limited to the exemplary embodiment. It will be understood by those of ordinary skill in the art that various changes in form and details may be made therein without departing from the spirit and scope of the present invention as defined by the claims. For example, in the description of the above-mentioned exemplary embodiment, the metal plate (or ring-like metal plate) 40 is taken as an example of the fastening plate (or ring-like fastening plate), but alternatively, the fastening plate (or ring-like fastening plate) may be made of another material than metal as long as the use of the material allows fastening with the plurality of screws.

This application is based upon and claims the benefit of priority from Japanese Patent Application No. 2008-319714, filed on Dec. 16, 2008, the disclosure of which is incorporated herein in its entirety by reference.

1. An antenna, comprising:
a first face plate;
a second face plate parallel to the first face plate; and
a power supply section comprising:
an apical portion; and
a flange-like short-circuit section,
wherein the first face plate comprises:
a first thin metal plate on an outer side; and
a first dielectric plate on an inner side,
wherein the second face plate comprises:
a second thin metal plate on the outer side; and
a second dielectric plate on the inner side,
wherein the antenna further comprises a fastening plate on the inner side of the second dielectric plate,
wherein the second thin metal plate, the second dielectric plate, and the fastening plate each comprise, at a center portion thereof, a hole for the power supply section allowing insertion of the apical portion and forbidding insertion of the flange-like short-circuit section,
wherein the flange-like short-circuit section, the second thin metal plate, and the second dielectric plate each comprise a plurality of insertion holes, through which a plurality of screws are inserted,
wherein the fastening plate comprises a plurality of tapped holes, into which the plurality of screws are threadingly inserted, and
wherein, under a state in which the apical portion is inserted from the outer side of the second face plate into the hole for the power supply section of the second thin metal plate, the second dielectric plate, and the fastening plate, the plurality of screws are inserted from the outer side of the flange-like short-circuit section through the plurality of insertion holes of the flange-like short-circuit section, the second thin metal plate, and the second dielectric plate, and the plurality of screws are threadingly inserted into the plurality of tapped holes of the fastening plate so that electrical conductivity between the flange-like short-circuit section and the second thin metal plate is established through direct contact.

2. An antenna according to claim 1, wherein, under the state in which the apical portion is inserted from the outer side of the second face plate into the hole for the power supply section of the second thin metal plate, the second dielectric plate, and the fastening plate, the plurality of screws are inserted from the outer side of the flange-like short-circuit section through the plurality of insertion holes of the flange-like short-circuit section, the second thin metal plate, and the second dielectric plate, and the plurality of screws are threadingly inserted into the plurality of tapped holes of the fastening plate so that the electrical conductivity between the flange-like short-circuit section and the second thin metal plate is established through the direct contact without soldering.

3. An antenna according to claim 1, wherein, under the state in which the apical portion is inserted from the outer side of the second face plate into the hole for the power supply section of the second thin metal plate, the second dielectric plate, and the fastening plate, the plurality of screws are inserted from the outer side of the flange-like short-circuit section through the plurality of insertion holes of the flange-like short-circuit section, the second thin metal plate, and the second dielectric plate, and the plurality of screws are threadingly inserted into the plurality of tapped holes of the fastening plate so that the power supply section is fixed to the second face plate, and the electrical conductivity between the flange-like short-circuit section and the second thin metal plate is established through the direct contact without soldering.

4. An antenna according to claim 1, wherein the fastening plate comprises a ring-like fastening plate having the hole for the power supply section formed at the center portion thereof.

5. An antenna according to claim 4, further comprising a dielectric honeycomb between the first dielectric plate and the ring-like fastening plate, and between the first dielectric plate and the second dielectric plate.

6. An antenna according to claim 1, wherein the first thin metal plate and the second thin metal plate are each made of copper foil.

7. An antenna according to claim 1, wherein the first face plate comprises a slot.

8. An antenna according to claim 1, wherein the antenna comprises an antenna to be mounted on a satellite.

9. A manufacturing method for an antenna,
the antenna comprising:
a first face plate;
a second face plate parallel to the first face plate; and
a power supply section comprising:
an apical portion; and
a flange-like short-circuit section,
the manufacturing method comprising, when fixing the power supply section to the second face plate:
preparing, as the second face plate, a face plate comprising a thin metal plate on an outer side and a dielectric plate on an inner side;
further preparing a fastening plate on the inner side of the dielectric plate,
the thin metal plate, the dielectric plate, and the fastening plate each comprising, at a center portion thereof, a hole for the power supply section allowing insertion of the apical portion and forbidding insertion of the flange-like short-circuit section,
the flange-like short-circuit section, the thin metal plate, and the dielectric plate each comprising a plurality of insertion holes, through which a plurality of screws are inserted,
the fastening plate comprising a plurality of tapped holes, into which the plurality of screws are threadingly inserted; and
under a state in which the apical portion is inserted from the outer side of the second face plate into the hole for the power supply section of the thin metal plate, the dielectric plate, and the fastening plate, inserting the plurality of screws from the outer side of the flange-like short-circuit section through the plurality of insertion holes of the flange-like short-circuit section, the thin metal plate, and the dielectric plate, and threadingly inserting the plurality of screws into the plurality of tapped holes of the fastening plate so that electrical conductivity between the flange-like short-circuit section and the thin metal plate is established through direct contact.

10. A manufacturing method for an antenna according to claim 9, wherein, under the state in which the apical portion is inserted from the outer side of the second face plate into the hole for the power supply section of the thin metal plate, the dielectric plate, and the fastening plate, the plurality of screws are inserted from the outer side of the flange-like short-circuit section through the plurality of insertion holes of the flange-like short-circuit section, the thin metal plate, and the dielectric plate, and the plurality of screws are threadingly inserted into the plurality of tapped holes of the fastening plate so that the electrical conductivity between the flange-like short-circuit section and the thin metal plate is established through the direct contact without soldering.

11. A manufacturing method for an antenna according to claim 9, wherein the fastening plate comprises a ring-like fastening plate having the hole for the power supply section formed at the center portion thereof.

12. A manufacturing method for an antenna according to claim 9, wherein the thin metal plate is made of copper foil.

13. A manufacturing method for an antenna according to claim 9, wherein the antenna comprises an antenna to be mounted on a satellite.

14. An antenna according to claim 2, wherein the fastening plate comprises a ring-like fastening plate having the hole for the power supply section formed at the center portion thereof.

15. An antenna according to claim 3, wherein the fastening plate comprises a ring-like fastening plate having the hole for the power supply section formed at the center portion thereof.

16. An antenna according to claim 2, wherein the first thin metal plate and the second thin metal plate are each made of copper foil.

17. An antenna according to claim 3, wherein the first thin metal plate and the second thin metal plate are each made of copper foil.

18. An antenna according to claim 4, wherein the first thin metal plate and the second thin metal plate are each made of copper foil.

19. An antenna according to claim 5, wherein the first thin metal plate and the second thin metal plate are each made of copper foil.

20. An antenna according to claim 2, wherein the first face plate comprises a slot.
